(19) United States
(12) Patent Application Publication
(10) Pub. No.: US 2018/0048624 A1
(43) Pub. Date: Feb. 15, 2018

(54) EXTENSIBLE, PLUG-N-PLAY, PRIVATE, SECURE NETWORK GATEWAY

(71) Applicant: ESMART TECH, INC., San Diego, CA (US)

(72) Inventors: Kenny Fok, San Diego, CA (US); David Diplock, Alpine, CA (US); Niral Bhalodia, San Diego, CA (US); Li Chen, Beijing (CN); Ying Xiong, San Diego, CA (US)

(21) Appl. No.: 15/671,755

(22) Filed: Aug. 8, 2017

Related U.S. Application Data
(60) Provisional application No. 62/374,712, filed on Aug. 12, 2016.

(51) Int. Cl. H04L 29/06; H04L 9/30

(52) U.S. Cl. CPC H04L 63/0272; H04L 9/30; H04L 63/061

(57) ABSTRACT

An automated method of establishing a virtual private network (VPN) includes: sending, from a secure gateway, a request to a remote server; receiving a response to the request from the server; providing, at the gateway, a graphic code comprising a set of VPN attributes; and providing, at the gateway, access to the VPN. An automated method of establishing a VPN includes: receiving, at a server, a request from a secure gateway; sending a response to the request to the gateway; and providing, to a user device, VPN configuration information. An automated method of establishing a VPN includes: generating, at a secure gateway, a key pair including a public key and a private key; generating a request; sending the request to a remote server; receiving, at the gateway, a response to the request; and providing, at the gateway, a graphic code comprising a set of VPN attributes.

### CROSS-REFERENCE TO RELATED APPLICATIONS

This application claims priority to U.S. Provisional Patent Application Ser. No. 62/374,712, filed on Aug. 12, 2016.

### BACKGROUND

Network access is ubiquitous. Many users may access the Internet using a router or other appropriate device that utilizes an insecure, unencrypted, interface protocol.

A virtual private network (VPN) protocol may allow users to communicated over an encrypted tunnel. Such a VPN may require a number of complex operations (e.g., certificate retrieval, client setup, domain or fixed internet protocol (IP) address setup, etc.) in order to enable secure communications.

Thus there exists a need for a solution that allows users to easily and automatically set up a VPN connection.

### SUMMARY

Some embodiments may provide a secure network gateway. The gateway may be able to connect to a modem or other appropriate access or interface element. The gateway may further be able to connect to a router or other appropriate connection element.

In order to configure secure network access, the gateway may generate a public and private key pair and encrypt a virtual private network (VPN) certificate using the private key. The encrypted certificate may then be sent to a remote server. In some embodiments, the gateway may also send an IP address, the public key, media access control (MAC) address (as a unique identifier), and/or other appropriate information related to the gateway. Such information may be encrypted using the public key.

The server may respond with a message included an encrypted secure server uniform resource locator (URL) and/or other appropriate information. Such information may be encrypted using the public key. The secure server URL may provide access to information stored at the server, including the IP address, public key, MAC address, etc. Such information may be encrypted using the public key.

The gateway may include a display that is able to provide a graphic code such as a quick response (QR) code for capture by a user device such as a smartphone or tablet. The graphic code may include VPN attributes such as the private key and the secure server URL. Providing the private key via the graphic code requires physical access to the gateway device during configuration as the private key is not shared elsewhere.

The user device may scan the graphic code and extract the private key and server URL. The user device may then navigate to the secure server URL and fetch the encrypted VPN configuration information including the VPN certificate and a domain name provided by the server, where the domain (or fixed IP address) is associated with the gateway. The user device may then use the private key to decrypt the VPN certificate and the public key to decrypt the domain name (and/or other information associated with the VPN and/or gateway).

A secure VPN connection may be established between the user device and the secure gateway using the decrypted VPN certificate, domain name, and/or other appropriate VPN information, thus allowing the user device to securely access various networks (e.g., the Internet) via the router, gateway, and modem.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a system utilizing a secure gateway according to an exemplary embodiment;

FIG. 2 illustrates a communication flow diagram including components of the system of FIG. 1;

FIG. 3 illustrates a flow chart of an exemplary client-side process that establishes a secure gateway connection;

FIG. 4 illustrates a flow chart of an exemplary client-side process that establishes a secure connection at a user device;

FIG. 5 illustrates a flow chart of an exemplary server-side process that establishes a secure gateway connection; and

FIG. 6 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide an extensible, plug-n-play, private, secure network gateway.

A first exemplary embodiment provides an automated method of establishing a virtual private network (VPN). The method includes: sending, from a secure gateway, a request to a remote server; receiving, at the secure gateway, a response to the request from the remote server; providing, at the secure gateway, a graphic code comprising a set of VPN attributes; and providing, at the secure gateway, access to the VPN.

A second exemplary embodiment provides an automated method of establishing a virtual private network (VPN). The method includes: receiving, at a server, a request from a secure gateway; sending, from the server, a response to the request to the secure gateway; and providing, to a user device, VPN configuration information.

A third exemplary embodiment provides an automated method of establishing a virtual private network (VPN). The method includes: generating, at a secure gateway, a key pair including a public key and a private key; generating, at the secure gateway, a request; sending, from the secure gateway, the request to a remote server; receiving, at the secure gateway, a response to the request from the remote server; and providing, at the secure gateway, a graphic code comprising a set of VPN attributes.

Several more detailed embodiments are described in the sections below. Section I provides a description of a system architecture used by some embodiments. Section II then describes various algorithms used by some embodiments. Lastly, Section III describes a computer system which implements some of the embodiments.

### I. System Architecture

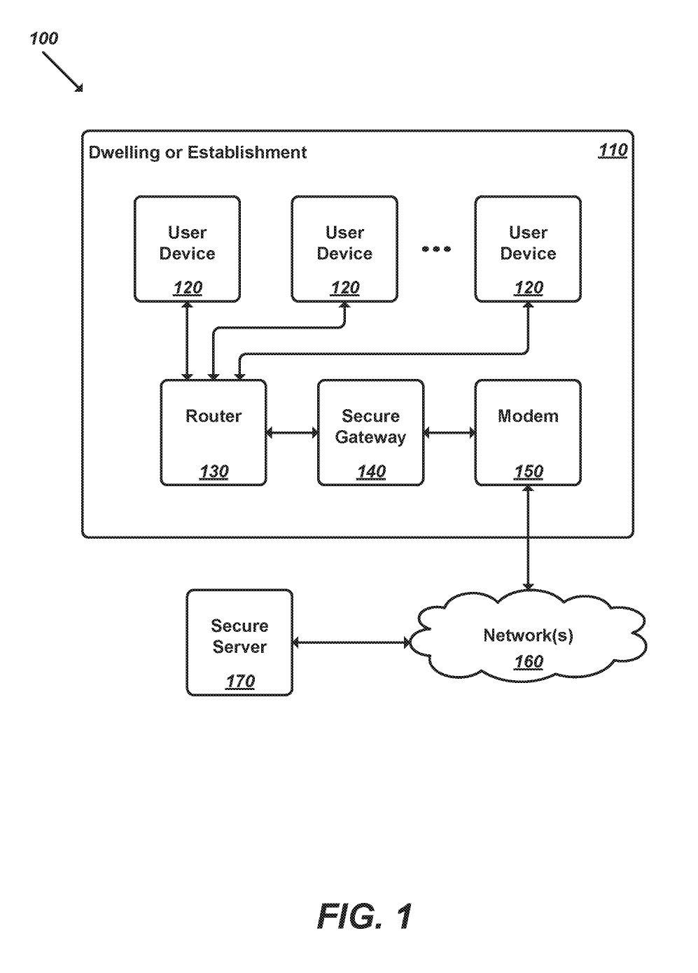

FIG. 1 illustrates a schematic block diagram of a system 100 utilizing a secure gateway according to an exemplary embodiment. As shown, the system may be associated with a dwelling or establishment 110 and may include a number of user devices 120, a router 130, a secure gateway 140, a modem 150, one or more networks 160, and a secure server 170.

The dwelling or establishment 110 may be a home, business, area, etc. that has at least one network connection and at least one secure gateway 140. Although the dwelling 110 may be a physical structure or area, the dwelling may also be defined in other appropriate ways. For instance, any devices that are able to connect to the router 130 may be associated with the dwelling whether or not the devices are within the physical structure or area. In addition, some embodiments may include multiple dwellings 110 within one system 100.

Each user device 120 may be an electronic computing device such as a smartphone, tablet, laptop, desktop, wearable device, smartTV, gaming console, etc. The user device may be able to communicate across one or more interfaces, channels, or pathways such as wireless pathways (e.g., Bluetooth, WiFi, etc.), wired pathways (e.g., USB connections, Ethernet connections, etc.), etc.

The router 130 may be a wired and/or wireless router that is able to connect to one or more user devices 120, the gateway 140, and/or other appropriate devices such as printers, Internet of things (IoT) devices, etc. Some embodiments may include multiple routers 130 or sets of routers.

The secure gateway 140 of some embodiments may provide enterprise-class network security to protect the user devices 120. The secure gateway 140 may be an electronic device that includes one or more computing elements such as processors, memory, etc. In addition, the gateway may include various user interface elements such as displays, buttons, keypads, touchscreens, etc. The gateway may include various hardware and/or software interfaces that may allow the gateway to connect to other elements such as the router 130 or the modem 150.

The secure gateway may be able to encrypt network traffic, hide identifying information such as IP address from hackers or spies, and allow anonymous web surfing. Such security may be provided without monitoring, inspecting, or logging any user activities. In addition, the gateway does not add latency to network communications or otherwise negatively impact communication speeds.

In addition, the secure gateway may be extensible and able to serve as a personal cloud and/or IoT gateway. The secure gateway may be able to automatically retrieve and implement updates from the server 170.

Some embodiments may include multiple secure gateway devices 140 associated with one dwelling 110.

The modem 150 may be an electronic device capable of sending and receiving communications over a broadband or other appropriate network. In some embodiments, the modem 150 and router 130 may be included in a single device. Such a combined device may be able to connect to the secure gateway in various appropriate ways (e.g., via an Ethernet connection, through a wired USB connector, via a wireless communications channel, etc.).

The network(s) 160 may include various wired and/or wireless networks such as Ethernet, cellular networks, local area wireless networks, telecommunications networks, satellite communication networks, the Internet, etc.

The secure server 170 of some embodiments may be able to communicate with the secure gateway 140 and/or other system components via the networks 160. The server 170 may include one or more computing devices, associated storages, and/or other appropriate elements.

Although system 100 has been described with reference to various exemplary details, one of ordinary skill in the art will recognize that the system may be implemented in various different ways without departing from the scope of the disclosure. For instance, some embodiments may include additional devices and/or omit various devices. In addition, the devices may be arranged in various different ways with various different communication pathways.

### II. Methods of Operation

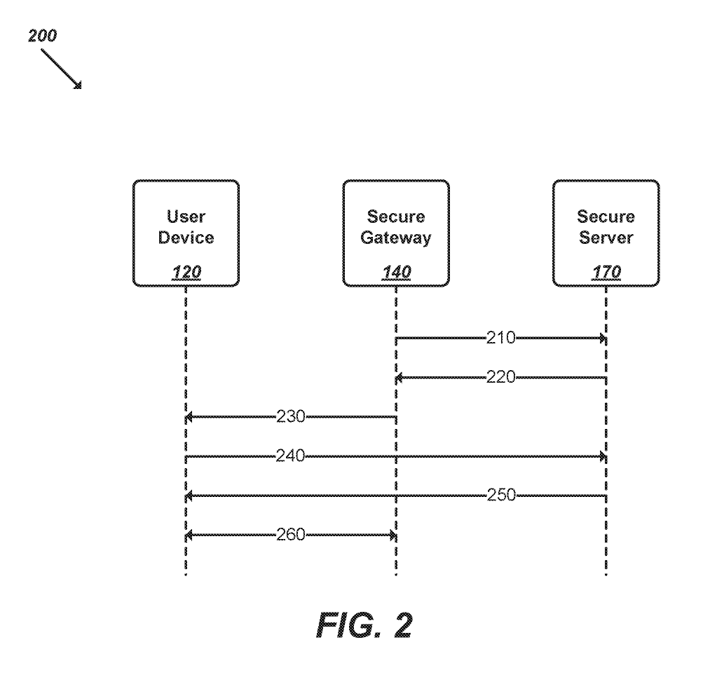

FIG. 2 illustrates a communication flow diagram 200 including components of the system 100. Such a communication flow may be used to establish a secure VPN connection to the dwelling or establishment 110 described above (and/or associated routers 130, modems 150, and/or other components).

Existing solutions are cumbersome and not user friendly. For instance, a user may have to retrieve a certificate using a file explorer, download the certificate to a user device, set up a VPN client on the user device, all while making sure that the home VPN is accessible via the Internet (e.g., using a domain name or fixed IP address).

Communication flow 200 may be implemented when a user wishes to configure a VPN. The secure gateway 140 may encrypt a VPN certificate using a private key. The gateway may then send a message 210 including the encrypted VPN certificate to the server 170. In addition, the gateway 140 may encrypt (using a public key) and send an IP address, public key, MAC address (as a unique identifier), and/or other appropriate information related to the gateway 140. The server 170 may send a response 220 that includes an encrypted URL (encrypted using the public key) and/or other appropriate information.

Next, the user device 120 may capture 230 a graphic code (e.g., a QR code) displayed by the gateway 140. The graphic code may include a private key and the secure server URL. The private key may be presented only as a graphic code, thus requiring physical access to the gateway device. The user device 120 may extract the private key and server URL.

The user device 120 may then navigate 240 to the server URL and fetch 250 the encrypted VPN configuration information including the VPN certificate and domain name. The user device 120 may then use the private key to decrypt the VPN certificate and the public key to decrypt the domain name.

Next, the user device may establish a VPN connection 260 to the secure gateway 140 using the decrypted VPN certificate and domain name, thus allowing the user device 120 to securely access the network(s) 160.

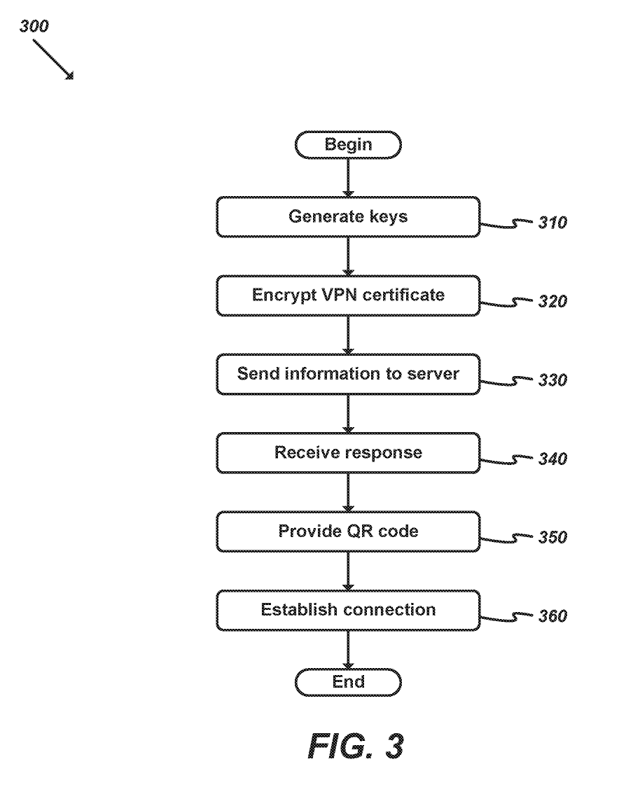

FIG. 3 illustrates a flow chart of an exemplary client-side process 300 that establishes a secure gateway connection. Such a process may be executed by an element such as gateway 140 described above. The process may begin, for instance, when the gateway is powered on.

As shown, the process may generate (at 310) a private and public key pair when the user first establishes an outgoing VPN connection, thus ensuring that the keys are unique. The keys may be two hundred fifty-six bits.

Next, the process may encrypt (at 320) a VPN certificate using the private key generated at 310. Next, the process may send (at 330) information to the server. Such information may include, for instance, the encrypted VPN certificate, the IP address of the gateway (or modem), a public key, and the MAC address of the gateway (or modem). In some cases (e.g., when the IP address of the gateway is updated), the gateway may automatically notify the server in order to refresh the information stored at the server.

Next, the process may receive (at 340) a response from the server. Such a response may include a secure server URL. The secure server URL may provide access to VPN configuration attributes such as domain name, IP address, MAC address, etc. Next, the process may provide (at 350) a graphic code that includes the private key and URL. The graphic code may be provided by an included display screen or other appropriate UI element.

The process may then establish (at 360) a connection to a user device and then may end.

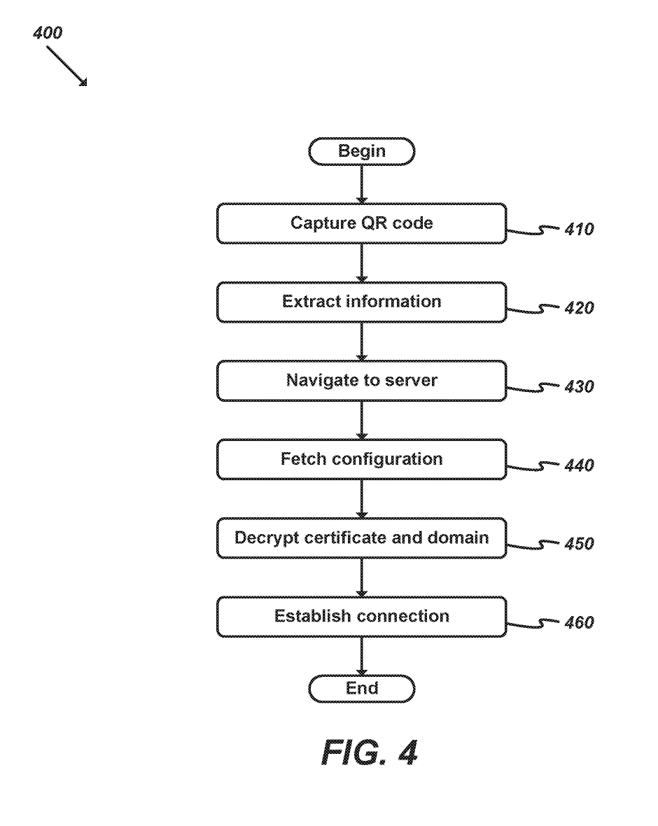

FIG. 4 illustrates a flow chart of an exemplary client-side process 400 that establishes a secure connection at a user device. Such a process may be executed by an element such as user device 120 described above. Process 400 may be performed using various appropriate user device applications or apps, such as a web browser, a dedicated gateway app, etc. The process may begin, for instance, when connecting a user device via the gateway 140. Process 400 may be complementary to process 300 described above.

As shown, the process may capture (at 410) a graphic code provided by the gateway (e.g., such as provided at operation 340 described above). Next, the process may extract (at 420) information from the captured code. Such information may include the private key and secure server URL described above.

Process 400 may then navigate (at 430) to the server using the URL extracted from the code. Next, the process may fetch (at 440) configuration information from the server, including a VPN certificate (previously encrypted using the private key) and domain name associated with the gateway, where the domain name and/or other attributes may have been encrypted using the public key.

The process may then decrypt (at 450) the certificate using the private key and the domain name (and/or other attributes provided by the secure server URL) using the public key. Finally, the process may establish (at 460) a connection to the gateway using the decrypted information and then may end.

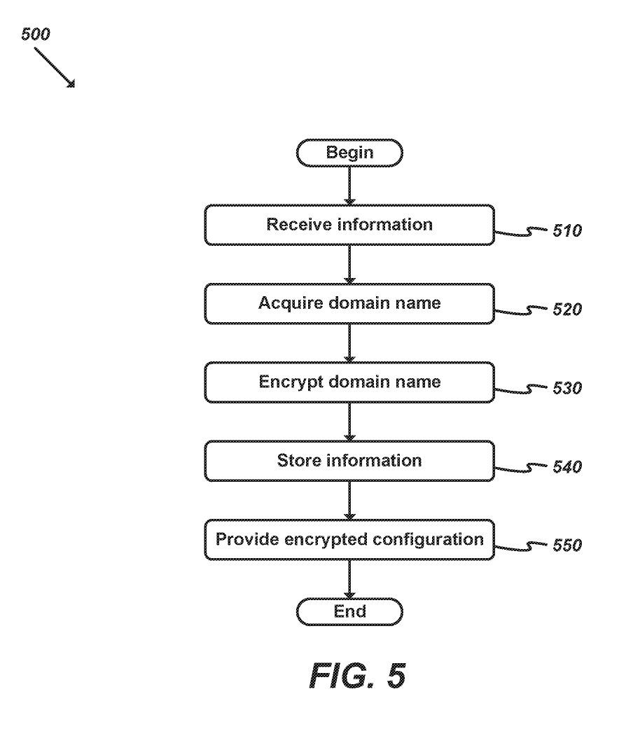

FIG. 5 illustrates a flow chart of an exemplary server-side process 500 that establishes a secure gateway connection. Such a process may be executed by an element such as server 170 described above. The process may begin, for instance, when a request is received from the gateway 140. Process 500 may be complementary to processes 300 and/or 400 described above.

As shown, the process may receive (at 510) information from the gateway. Such information may include the encrypted VPN certificate, IP address, public key, and MAC address, as described in reference to operation 320 above.

Next, the process may acquire (at 520) a domain name for the IP address and encrypt (at 530) the domain name. The domain name may be acquired in various appropriate ways (e.g., a look-up table or database, generation of a unique domain on demand, etc.). In some embodiments, the domain name may include information associated with the gateway (e.g., a portion of the MAC address, serial number, etc.).

Process 500 may then store (at 540) information including the domain name, VPN certificate, IP address, public key, MAC address, etc. Such information may be stored in a database or look-up table associated with the server. The information may be encrypted using the public key in some embodiments. The information may be provided to user devices (and/or other appropriate system components) via a secure server URL associated with the gateway.

Next, process 500 may provide (at 550) the encrypted configuration information to the gateway and then may end. The encrypted configuration information may include the secure server URL.

After configuring the gateway as described in reference to FIGS. 3-5, the user device (and/or other user devices or IoT devices or cloud features) may be able to utilize the VPN simply by accessing the router or other device as usual without the need for any further configuration.

One of ordinary skill in the art will recognize that the various processes and communication flows described above may be implemented in various different ways without departing from the scope of the disclosure. For instance, some embodiments may perform the operations in different orders. As another example, some embodiments may include additional operations and/or omit listed operations. As still another example, some operations and/or sets of operations may be performed iteratively and/or based on some specified criteria.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

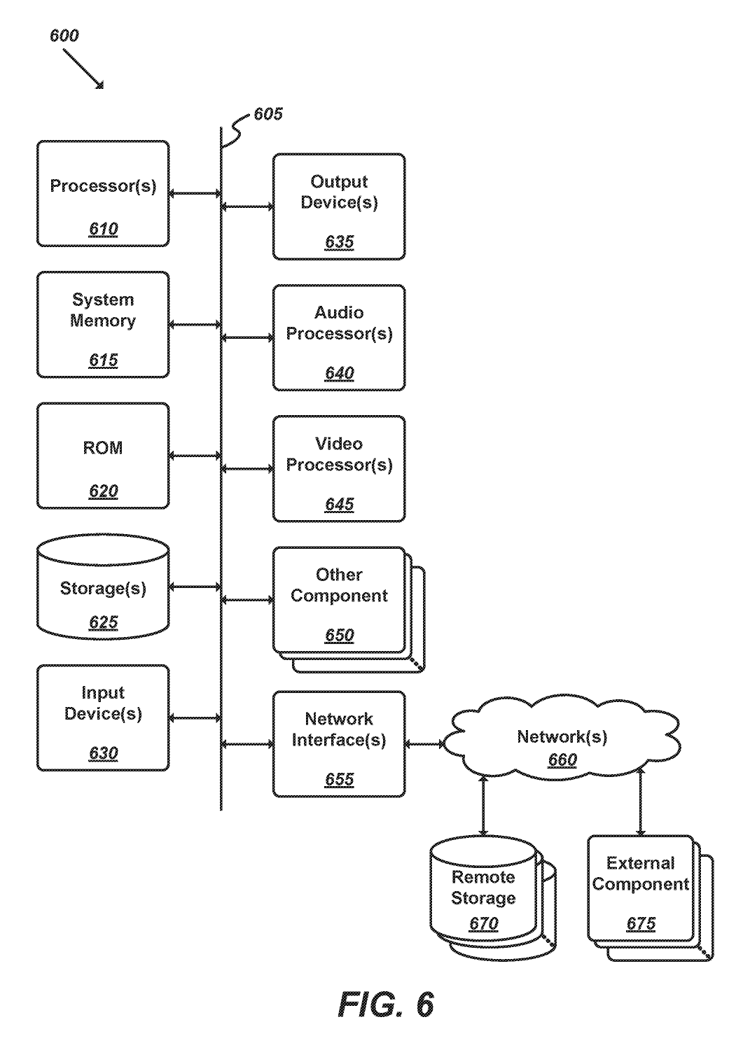

FIG. 6 illustrates a schematic block diagram of an exemplary computer system 600 used to implement some embodiments. For example, the system described above in reference to FIG. 1 may be at least partially implemented using computer system 600. As another example, the processes and algorithms described in reference to FIG. 3-FIG. 5 may be at least partially implemented using sets of instructions that are executed using computer system 600.

Computer system 600 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 600 may include at least one communication bus 605, one or more processors 610, a system memory 615, a read-only memory (ROM) 620, permanent storage devices 625, input devices 630, output devices 635, audio processors 640, video processors 645, various other components 650, and one or more network interfaces 655.

Bus 605 represents all communication pathways among the elements of computer system 600. Such pathways may include wired, wireless, optical, and/or other appropriate communication pathways. For example, input devices 630 and/or output devices 635 may be coupled to the system 600 using a wireless connection protocol or system.

The processor 610 may, in order to execute the processes of some embodiments, retrieve instructions to execute and/or data to process from components such as system memory 615, ROM 620, and permanent storage device 625. Such instructions and data may be passed over bus 605.

System memory 615 may be a volatile read-and-write memory, such as a random access memory (RAM). The system memory may store some of the instructions and data that the processor uses at runtime. The sets of instructions and/or data used to implement some embodiments may be stored in the system memory 615, the permanent storage device 625, and/or the read-only memory 620. ROM 620 may store static data and instructions that may be used by processor 610 and/or other elements of the computer system.

Permanent storage device 625 may be a read-and-write memory device. The permanent storage device may be a non-volatile memory unit that stores instructions and data even when computer system 600 is off or unpowered. Computer system 600 may use a removable storage device and/or a remote storage device as the permanent storage device.

Input devices 630 may enable a user to communicate information to the computer system and/or manipulate various operations of the system. The input devices may include keyboards, cursor control devices, audio input devices and/or video input devices. Output devices 635 may include printers, displays, audio devices, etc. Some or all of the input and/or output devices may be wirelessly or optically connected to the computer system 600.

Audio processor 640 may process and/or generate audio data and/or instructions. The audio processor may be able to receive audio data from an input device 630 such as a microphone. The audio processor 640 may be able to provide audio data to output devices 640 such as a set of speakers. The audio data may include digital information and/or analog signals. The audio processor 640 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 645 (or graphics processing unit) may process and/or generate video data and/or instructions. The video processor may be able to receive video data from an input device 630 such as a camera. The video processor 645 may be able to provide video data to an output device 640 such as a display. The video data may include digital information and/or analog signals. The video processor 645 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 650 may perform various other functions including providing storage, interfacing with external systems or components, etc.

Finally, as shown in FIG. 6, computer system 600 may include one or more network interfaces 655 that are able to connect to one or more networks 660. For example, computer system 600 may be coupled to a web server on the Internet such that a web browser executing on computer system 600 may interact with the web server as a user interacts with an interface that operates in the web browser. Computer system 600 may be able to access one or more remote storages 670 and one or more external components 675 through the network interface 655 and network 660. The network interface(s) 655 may include one or more application programming interfaces (APIs) that may allow the computer system 600 to access remote systems and/or storages and also may allow remote systems and/or storages to access computer system 600 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 600 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

We claim:

1. An automated method of establishing a virtual private network (VPN), the method comprising:
sending, from a secure gateway, a request to a remote server;
receiving, at the secure gateway, a response to the request from the remote server;
providing, at the secure gateway, a graphic code comprising a set of VPN attributes; and
providing, at the secure gateway, access to the VPN.

2. The automated method of claim 1, wherein the request comprises a VPN certificate.

3. The automated method of claim 1, wherein the response includes a secure server uniform resource locator (URL).

4. The automated method of claim 3, wherein the set of VPN attributes comprises a private key and the secure server URL.

5. The automated method of claim 1 further comprising providing, at the secure gateway, access to at least one network via a modem.

6. The automated method of claim 5, wherein providing access to the VPN comprises providing, to a router, access to the at least one network.

7. The automated method of claim 6 further comprising providing, to at least one user device, access to the VPN via the router.

8. An automated method of establishing a virtual private network (VPN), the method comprising:
receiving, at a server, a request from a secure gateway;
sending, from the server, a response to the request to the secure gateway; and
providing, to a user device, VPN configuration information.

9. The automated method of claim 8, wherein the request comprises a VPN certificate.

10. The automated method of claim 9, wherein the response includes a secure server uniform resource locator (URL).

11. The automated method of claim 10, wherein the VPN configuration information comprises the VPN certificate and a domain name associated with the secure gateway.

12. The automated method of claim 11, wherein the VPN configuration information is provided via the secure server URL.

13. The automated method of claim 11 further comprising generating, at the server, the domain name.

14. The automated method of claim 8, wherein the request comprises a public key.

15. An automated method of establishing a virtual private network (VPN), the method comprising:
generating, at a secure gateway, a key pair comprising a public key and a private key;
generating, at the secure gateway, a request;
sending, from the secure gateway, the request to a remote server;
receiving, at the secure gateway, a response to the request from the remote server; and
providing, at the secure gateway, a graphic code comprising a set of VPN attributes.

16. The automated method of claim 15 further comprising, at the secure gateway, encrypting a VPN certificate using the private key.

17. The automated method of claim 16, wherein the request comprises the encrypted VPN certificate, the public key, an internet protocol (IP) address of the secure gateway, and a media access control (MAC) address of the secure gateway.

18. The automated method of claim 17, wherein the response comprises a secure server URL that provides access to the encrypted VPN certificate.

19. The automated method of claim 18, wherein the set of VPN attributes comprises the private key and the secure server URL.

20. The automated method of claim 19 further comprising:
receiving, at the secure gateway, a request for access from a user device; and
providing access to the user device when the request for access comprises the VPN certificate decrypted using the private key.
